(19) United States
(12) Patent Application Publication
(10) Pub. No.: US 2006/0072681 A1
(43) Pub. Date: Apr. 6, 2006

(54) Scalable gain retraining generator, method of gain retraining and multiple-input, multiple-output communications system employing the generator or method

(75) Inventors: Manish Goel, Plano, TX (US); Michael T. DiRenzo, Coppell, TX (US); David P. Magee, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/956,406

(22) Filed: Oct. 1, 2004

(51) Int. Cl. H04B 7/02

(52) U.S. Cl. 375/267

(57) ABSTRACT

The present invention provides a gain retraining generator for use with a MIMO transmitter employing N transmit antennas, where N is at least two. In one embodiment, the gain retraining generator includes a first sequence encoder configured to provide a gain retraining sequence to one of the N transmit antennas during a non-initial time interval. The gain retraining generator also includes a second sequence encoder coupled to the first sequence encoder and configured to further provide (N-1) alternative gain retraining sequences to (N-1) remaining transmit antennas, respectively, during the non-initial time interval to retrain receive gains for multiple concurrent data transmissions.

### TECHNICAL FIELD OF THE INVENTION

The present invention is directed, in general, to communication systems and, more specifically, to a scalable gain retraining generator, a method of gain retraining and a multiple-input, multiple-output (MIMO) communications system employing the generator or method.

### BACKGROUND OF THE INVENTION

Multiple-input, multiple-output (MIMO) communication systems differ from single-input, single-output (SISO) communication systems in that different data symbols are transmitted simultaneously using multiple antennas. MIMO systems typically employ a cooperating collection of single-dimension transmitters to send a vector symbol of information, which may represent one or more coded or uncoded SISO data symbols. A cooperating collection of single-dimension receivers, constituting a MIMO receiver, then receives one or more copies of this transmitted vector of symbol information. The performance of the entire communication system hinges on the ability of the MIMO receiver to establish reliable estimates of the symbol vector that was transmitted. This includes establishing several parameters, which includes receiver automatic gain control (AGC) for the receive signal.

As a result, training sequences contained in preambles that precede data transmissions are employed to train AGCs to an appropriate level for each receive signal data path. This allows optimal MIMO data decoding to be performed at the MIMO receiver. AGC training and a resulting AGC level typically differ between SISO and MIMO communication systems since the power of the respective receive signals is different. Therefore, a receiver AGC may converge to an inappropriate level for MIMO data decoding if the preamble structure is inappropriate.

For example, a 2×2 MIMO communication system employing orthogonal frequency division multiplexing (OFDM) may transmit two independent and concurrent signals, employing two single-dimension transmitters having separate transmit antennas and two single-dimension receivers having separate receive antennas. Two receive signals Y₁(k), Y₂(k) on the k^{th} sub-carrier/tone following a Fast Fourier Transformation and assuming negligible inter-symbol interference may be written as:
Y₁(k)=H₁₁(k)*X₁(k)+H₁₂(k)*X₂(k)+N₁(k) (1)
Y₂(k)=H₂₁(k)*X₁(k)+H₂₂(k)*X₂(k)+N₂(k) (2)
where X₁(k) and X₂(k) are two independent signals transmitted on the k^{th} sub-carrier/tone from the first and second transmit antennas, respectively, and N₁(k) and N₂(k) are noises associated with the two receive signals.

The channel coefficients Hᵢⱼ(k), where i=1,2 and j=1,2, incorporates gain and phase distortion associated with symbols transmitted on the k^{th} sub-carrier/tone from transmit antenna j to receive antenna i. The channel coefficients Hᵢⱼ(k) may also include gain and phase distortions due to signal conditioning stages such as filters and other analog electronics. The receiver is required to provide estimates of the channel coefficients Hᵢⱼ(k) to reliably decode the transmitted signals X₁(k) and X₂(k).

At the first receive antenna, the time domain representation of the channel coefficients from the first and second transmit antennas are given by h₁₁[n] and h₁₂[n] respectively. A receiver AGC could be trained by employing a single gain training sequence portion of a preamble resulting in a receive signal power of ∥h₁₁∥₂² at antenna one of the receiver.

Here, ∥h₁₁∥₂² is the square of the 2 norm of the time domain channel representation from transmit antenna 1 to receive antenna 1. Then the AGC level may be derived by employing the receiver analog-to-digital converter dynamic range (ADC_{DR}), the square root of the channel power ∥h₁₁∥₂ and a backoff level using the expression ADC_{DR}/(backoff level)/∥h₁₁∥₂. The backoff level is a measure of the peak-to-mean receive signal power values expected. For example, a backoff level of 12 dB (4:1 peak-to-mean) allows for two bits in the ADC conversion to accommodate peak values before clipping occurs. This AGC setting would ensure receiving a maximum signal strength for this backoff level in a SISO system. However, for MIMO operation, both transmit antennas typically emit independent data to give a receive signal power of ∥h₁₁∥₂²+∥h₁₂∥₂² at a first receive antenna for example, which is different than that of the SISO system. This difference can cause clipping of some of the receive signals due to improperly set AGC levels and therefore generate transmission errors.

Accordingly, what is needed in the art is a gain encoding structure that accommodates both legacy receivers and MIMO transmissions.

### SUMMARY OF THE INVENTION

To address the above-discussed deficiencies of the prior art, the present invention provides a gain retraining generator for use with a MIMO transmitter employing N transmit antennas, where N is at least two. In one embodiment, the gain retraining generator includes a first sequence encoder configured to provide a gain retraining sequence to one of the N transmit antennas during a non-initial time interval. The gain retraining generator also includes a second sequence encoder coupled to the first sequence encoder and configured to further provide (N-1) alternative gain retraining sequences to (N-1) remaining transmit antennas, respectively, during said non-initial time interval to retrain receive gains for multiple concurrent data transmissions.

In another aspect, the present invention provides a method of gain retraining for use with a MIMO transmitter employing N transmit antennas, where N is at least two. The method includes providing a gain retraining sequence to one of the N transmit antennas during a non-initial time interval and further providing (N-1) alternative gain retraining sequences to (N-1) remaining transmit antennas, respectively, during the non-initial time interval to retrain receive gains for multiple concurrent data transmissions.

The present invention also provides, in yet another aspect, a MIMO communications system. The MIMO communications system includes a MIMO transmitter having N transmit antennas, where N is at least two, that provides multiple concurrent data transmissions. The MIMO communications system also includes a gain retraining generator that is coupled to the MIMO transmitter. The gain retraining generator has a first sequence encoder that provides a gain retraining sequence to one of the N transmit antennas during a non-initial time interval, and a second sequence encoder, coupled to the first sequence encoder, that further provides (N-1) alternative gain retraining sequences to (N-1) remaining transmit antennas, respectively, during the non-initial time interval to retrain receive gains for multiple concurrent data transmissions. The MIMO communications system further includes a MIMO receiver having M receive antennas, where M is at least two, that retrains the receive gains for the multiple concurrent data transmissions.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of an N×M MIMO communication system constructed in accordance with the principles of the present invention;

FIG. 2 illustrates a diagram of an embodiment of a transmission frame format employable with a gain retraining generator and constructed in accordance with the principles of the present invention;

FIG. 3 illustrates a flow diagram of an embodiment of a method of gain retraining carried out in accordance with the principles of the present invention.

### DETAILED DESCRIPTION

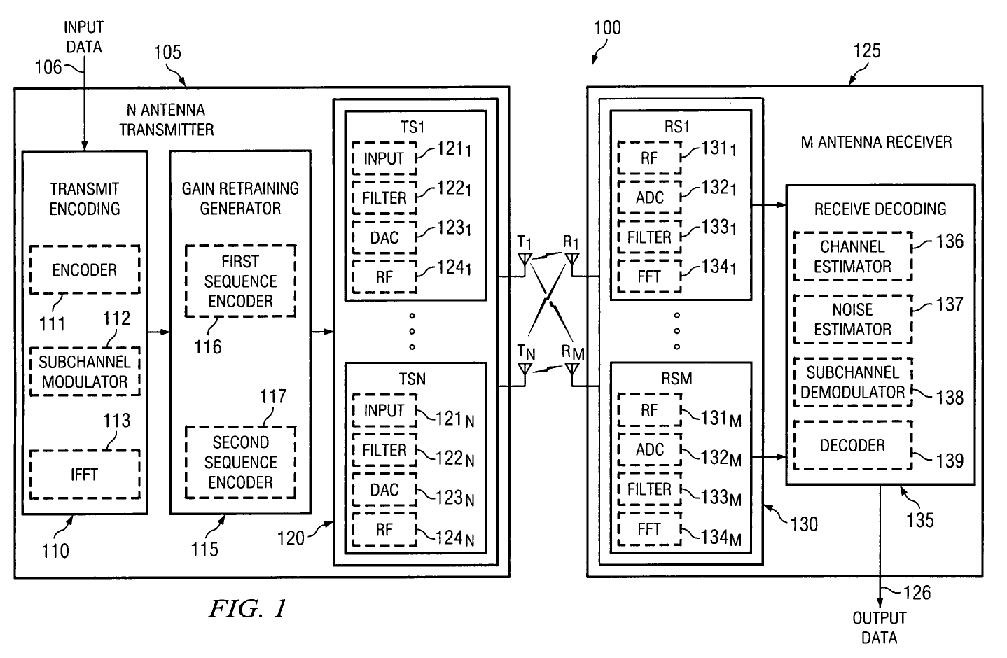

Referring initially to FIG. 1, illustrated is a system diagram of an embodiment of an N×M MIMO communication system, generally designated 100, constructed in accordance with the principles of the present invention. The MIMO communication system 100 includes a MIMO transmitter 105 and a MIMO receiver 125. The MIMO transmitter 105 employs input data 106 and includes a transmit encoding system 110, a gain retraining generator 115 and a transmit system 120 having N transmit sections TS1-TSN coupled to N transmit antennas T1-TN, respectively. The receiver 125 includes a receive system 130 having M receive sections RS1-RSM respectively coupled to M receive antennas R1-RM, and a receive decoding system 135 providing output data 126. In the embodiment of FIG. 1, N and M are at least two and M≧N.

The transmit encoding system 110 includes an encoder 111, a subchannel modulator 112 and an Inverse Fast Fourier Transform (IFFT) section 113. The encoder 111, subchannel modulator 112 and IFFT section 113 prepare the input data and support the arrangement of preamble information and signal information for transmission by the transmit system 120. The gain retraining generator 115 includes a first sequence encoder 116 and a second sequence encoder 117, which cooperate with the transmit encoding system 110 to generate a preamble structure that provides a received signal power appropriate for a legacy system as well as one that accommodates multiple concurrent transmissions. This allows proper automatic gain control (AGC) training for a legacy system transmission as well as for the receiver 125 to process a MIMO transmission. Additionally, the first and second sequence encoders 116, 117 may be employed in either the frequency or time domain. For the time domain, an IFFT of the appropriate preamble information may be pre-computed and read from memory at the required transmission time.

The N transmit sections TS1-TSN include corresponding pluralities of N input sections 121₁-121_{N}, N filters 122₁-122_{N}, N digital-to-analog converters (DACs) 123₁-123_{N} and N radio frequency (RF) sections 124₁-124_{N}, respectively. The N transmit sections TS1-TSN provide a time domain signal proportional to preamble information, signal information and input data for transmission by the N transmit antennas T1-TN, respectively.

The M receive antennas R1-RM receive the transmission and provide it to the M respective receive sections RS1-RSM, which include corresponding M RF sections 131₁-131_{M}, M analog-to-digital converters (ADCs) 132₁-132_{M}, M filters 133₁-133_{M}, and M Fast Fourier Transform (FFT) sections 134₁-134_{M}, respectively. The M receive sections RS1-RSM employ a proper AGC level to provide a frequency domain digital signal to the receive decoding system 135. This digital signal is proportional to the preamble information, signal information and input data. Setting of the proper AGC level is accomplished by establishing a proper ratio between a desired power level and a received power level for a selected ADC backoff level.

The receive decoding system 135 includes a channel estimator 136, a noise estimator 137, a subchannel demodulator 138 and a decoder 139 that employ the preamble information, signal information and input data to provide the output data 126. In the illustrated embodiment, the channel estimator 136 employs a portion of the preamble information for the purpose of estimating the communication channel coefficients.

In the gain retraining generator 115, the first sequence encoder 116 provides a gain retraining sequence to one of the N transmit antennas during a non-initial time interval. The second sequence encoder 117 is coupled to the first sequence encoder 116 and provides (N-1) alternative gain retraining sequences to the (N-1) remaining transmit antennas, respectively, during the non-initial time interval to retrain receive gains for multipleconcurrent data transmissions. The gain retraining sequence and the (N-1) alternative gain retraining sequences precede any additional MIMO preambles and MIMO data transmissions.

The gain retraining sequence follows a preamble that conforms to the IEEE 802.11a or the IEEE 802.11g standard. The gain training portion of this legacy preamble may be employed to establish the AGC of at least one intended legacy receiver. The MIMO transmitter 105 may operate as a SISO transmitter or appropriately transmit from some or all of its N transmit antennas to enhance the signal-to-noise ratio during reception. For the SISO case, null sequences may be transmitted from the other (N-1) transmit antennas during transmission of the legacy preamble. Alternatively, transmission from more than one transmit antenna during this time may employ training sequences (instead of null sequences) that are appropriate for proper decoding by the legacy receiver.

Alternatively, if a MIMO transmission is to be provided by the MIMO transmitter 105, the gain retraining sequence and the (N-1) alternative gain retraining sequences, which respectively follow the legacy preamble and the corresponding null sequences, are employed to retrain the associated gains of the MIMO receiver 125 to properly accommodate a MIMO transmission. The gain retraining sequence and the (N-1) alternative gain retraining sequences occur concurrently. For this case, the one or more legacy receivers will know from the preamble that the forthcoming transmission is to be ignored thereby allowing them to go into a standby mode for a period of time. This action avoids any overload effects that would otherwise result from trying to accommodate a MIMO transmission.

In one embodiment, the gain retraining sequence may be a repeat of the short sequence provided in the legacy preamble. Alternatively, the gain retraining sequence may be a different sequence as deemed appropriate to a particular application. In either case, each of the (N-1) alternative gain retraining sequences may be orthogonal to the gain retraining sequence. Here, orthogonality indicates that the cross-correlations between the gain retraining sequence and each of the (N-1) alternative gain retraining sequences are zero. This condition ensures that gain retraining is independent of any gain cross-retraining terms that would otherwise occur and inappropriately influence gain retraining.

Additionally, each of the (N-1) alternative gain retraining sequences and the gain retraining sequence may be substantially orthogonal resulting in cross-correlations that are substantially zero. Sequences that are substantially orthogonal and cross-correlations that are substantially zero provide gain cross-retraining terms that are nonzero, but whose influence on gain retraining is either negligibly or appropriately small for a given application.

The scalable property of the gain retraining generator 115 allows it to accommodate a MIMO transmitter that employs an N of two or more transmit antennas. This property accommodates an associated MIMO receiver, having an M of two or more receive antennas, to effectively provide receive AGC levels associated with each of the M receive antennas. These AGC levels are appropriate to accommodate additional MIMO preambles and MIMO data portions of a reception.

Those skilled in the pertinent art will understand that the present invention can be applied to conventional or future-developed MIMO communication systems. For example, these systems may form a part of a narrowband wireless communication system employing multiple antennas, a broadband communication system employing time division multiple access (TDMA) or orthogonal frequency division multiplex (OFDM) as well as a general multiuser communication system.

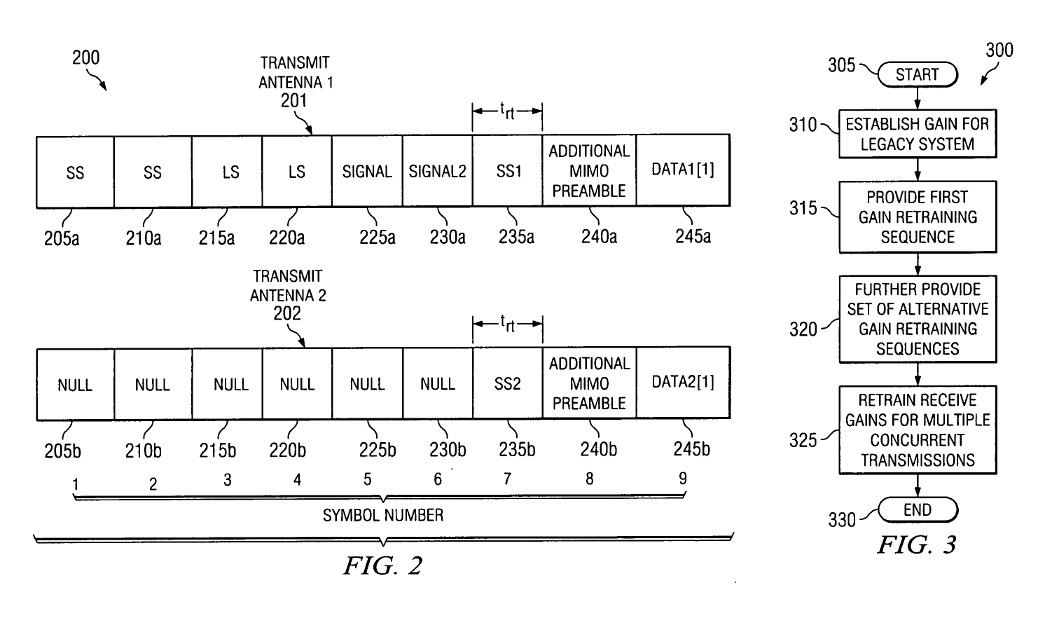

Turning now to FIG. 2, illustrated is a diagram of an embodiment of a transmission frame format, generally designated 200, employable with a gain retraining generator and constructed in accordance with the principles of the present invention. The transmission frame format 200 may be employed with a MIMO transmitter having first and second transmit antennas and a MIMO receiver having first and second receive antennas, as was generally discussed with respect to FIG. 1, where N and M are equal to two. The transmission frame format 200 includes first and second transmission frames 201, 202 that are associated with the first and second transmit antennas, respectively.

The first and second transmission frames 201, 202 include first and second gain training sequences 205a, 210a, first and second channel estimation training sequences 215a, 220a, first and second signal fields 225a, 230b and corresponding first, second, third, fourth, fifth and sixth null fields 205b, 210b, 215b, 220b, 225b, 230b, respectively. The first and second transmission frames 201, 202 also include a gain retraining sequence 235a and an alternative gain retraining sequence 235b, first additional MIMO preamble and data fields 240a, 245a, and corresponding second additional MIMO preamble and MIMO data fields 240b, 245b, respectively. The gain retraining sequence 235a and the alternative gain retraining sequence 235b occur at a gain retraining time interval tᵣₜ.

In the illustrated and alternative embodiments, the null sequences employed may be zero functions that by definition are zero almost everywhere, or null sequences of numerical values that converge to zero. Alternatively, the nulls may be an un-modulated transmission, a transmission employing substantially zero modulation or a period of no transmission. Of course, each of the nulls may be differing or the same employing current or future-developed formats, as advantageously required by a particular application.

In the illustrated embodiment, the first and second gain training sequences 205a, 210a, first and second channel estimation training sequences 215a, 220a and first signal field 225a form a preamble for a legacy system that conforms to a specification selected from the group consisting of IEEE 802.11a and IEEE 802.11g. A second signal field 230a provides a field for future wireless standard compatibility, which may be designated generally as IEEE 802.11n. The gain training sequences 205a, 210a are short sequences that, in concert with the first and second null fields 205b, 210b, ensure that an initial AGC setting provides a maximized signal strength for a given backoff level when employing a SISO signal. This signal strength is based on a receive signal power that corresponds to ∥h₁₁∥₂².

In the illustrated embodiment, the gain retraining sequence 235a is a sequence that is similar to the gain training sequences 205a, 210a, and the alternate gain retraining sequence 235b is a sequence that is orthogonal to the gain retraining sequence 235a. In alternative embodiments, the gain retraining sequence 235a conforms to the IEEE 802.11a or the IEEE 802.11g standard wherein the alternate gain retraining sequence 235b is again a sequence that is orthogonal to the gain retraining sequence 235a. The gain retraining and alternate gain retraining sequences 235a, 235b occur concurrently and are employed to retrain the receive AGC to accommodate the corresponding first and second additional MIMO preambles 240a, 240b and first and second MIMO data fields 245a, 245b, since these respectively also occur concurrently. The received signal power associated with these retraining sequences may be represented by a magnitude of ∥h₁₁∥₂²+∥h₁₂∥₂² for a first receive antenna, which is appropriate for receiving the MIMO transmissions.

Turning now to FIG. 3, illustrated is a flow diagram of an embodiment of a method of gain retraining, generally designated 300, carried out in accordance with the principles of the present invention. The method 300 may be employed with a MIMO transmitter having N transmit antennas and a MIMO receiver having M receive antennas, where N and M are at least two, and starts in a step 305.

In a step 310, an initial receive gain is established for at least one legacy system that corresponds to a specification that is selected from the group consisting of IEEE 802.11a and IEEE 802.11g. The initial receive gain employs a short sequence that is provided from only one of the N transmit antennas wherein a corresponding (N-1) null preamble fields is supplied from the (N-1) remaining transmit antennas, respectively. The initial receive gain is based on a received signal power corresponding to the square of a single channel coefficient.

Then, in a step 315, a gain retraining sequence is provided to one of the N transmit antennas. In the illustrated embodiment, the gain retraining sequence associated with the step 315 is also a short sequence that conforms to a standard selected from the group consisting of IEEE 802.11a and IEEE 802.11g, as before. In alternative embodiments, the gain retraining sequence may differ as required by another application of the present invention.

In a step 320, a set of (N-1) alternative gain retraining sequences is provided to the remaining (N-1) transmit antennas, respectively. In the illustrated embodiment, the gain retraining sequence is orthogonal to each member of the (N-1) alternative gain retraining sequences. In an alternative embodiment, the gain retraining sequence and each member of the set of (N-1) additional gain retraining sequences may be substantially orthogonal as allowed by a specific application. Additionally, the gain retraining sequence and the set of (N-1) alternative gain retraining sequences occur during the same time interval.

In a step 325, the gain retraining sequence and the set of (N-1) alternative gain retraining sequences retrain receive gains that accommodate multiple concurrent transmissions such as additional MIMO preambles or MIMO data. These receive gains are based on received signal powers corresponding to the sum of the squares of N channel coefficients. The method 300 ends in a step 330.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing a gain retraining generator, a method of gain retraining and a MIMO communications system employing the generator or method have been presented. Advantages include the ability to enhance the signal-to-noise ratio for MIMO transmissions that provide data and may provide additional preambles, as well. This enhancement is provided without having to sacrifice the structure of legacy preambles such as those that conform to specifications associated with IEEE 802.11a/g. Additionally, this gain retraining enhancement is scalable for N×M MIMO communications systems employing N transmit antennas and M receive antennas wherein each may be two or greater.

Although the present invention has been described in detail, those skilled in the art should understand that they can make various changes, substitutions and alterations herein without departing from the spirit and scope of the invention in its broadest form.

What is claimed is:

1. A gain retraining generator for use with a multiple-input, multiple output (MIMO) transmitter employing N transmit antennas, where N is at least two, comprising:
a first sequence encoder configured to provide a gain retraining sequence to one of said N transmit antennas during a non-initial time interval; and
a second sequence encoder coupled to said first sequence encoder and configured to further provide (N-1) alternative gain retraining sequences to (N-1) remaining transmit antennas, respectively, during said non-initial time interval to retrain receive gains for multiple concurrent data transmissions.

2. The generator as recited in claim 1 wherein each of said (N-1) alternative gain retraining sequences is orthogonal to said gain retraining sequence.

3. The generator as recited in claim 1 further configured to provide a preamble having a series arrangement of preamble fields wherein said preamble precedes said gain retraining sequence.

4. The generator as recited in claim 3 further configured to provide a series arrangement of null fields preceding each of said (N-1) alternative gain retraining sequences wherein each of said null fields corresponds to a separate preamble field of said preamble.

5. The generator as recited in claim 3 wherein said preamble conforms to a standard selected from the group consisting of:
IEEE 802.11a; and
IEEE 802.11g.

6. The generator as recited in claim 1 wherein said gain retraining sequence and said (N-1) alternative gain retraining sequences occur concurrently.

7. The generator as recited in claim 1 wherein each of said gain retraining sequence and said (N-1) alternative gain retraining sequences precedes a MIMO preamble.

8. A method of gain retraining for use with a multiple-input, multiple output (MIMO) transmitter employing N transmit antennas, where N is at least two, comprising:
providing a gain retraining sequence to one of said N transmit antennas during a non-initial time interval; and
further providing (N-1) alternative gain retraining sequences to (N-1) remaining transmit antennas, respectively, during said non-initial time interval to retrain receive gains for multiple concurrent data transmissions.

9. The method as recited in claim 8 wherein each of said (N-1) alternative gain retraining sequences is orthogonal to said gain retraining sequence.

10. The method as recited in claim 8 wherein said providing further includes a preamble having a series arrangement of preamble fields preceding said gain retraining sequence.

11. The method as recited in claim 10 wherein said further providing further includes a series arrangement of null fields preceding each of said (N-1) alternative gain retraining sequences where each of said null fields corresponds to a separate preamble field of said preamble.

12. The method as recited in claim 10 wherein said preamble conforms to a standard selected from the group consisting of:
IEEE 802.11a; and
IEEE 802.11g.

13. The method as recited in claim 8 wherein said providing said gain retraining sequence and said further providing said (N-1) alternative gain retraining sequences occur concurrently.

14. The method as recited in claim 8 wherein each of said providing said gain retraining sequence and said further providing said (N-1) alternative gain retraining sequences precedes a MIMO preamble.

15. A multiple-input, multiple-output (MIMO) communications system, comprising:
a MIMO transmitter employing N transmit antennas, where N is at least two, that provides multiple concurrent data transmissions;
a gain retraining generator that is coupled to said MIMO transmitter, including:
a first sequence encoder that provides a gain retraining sequence to one of said N transmit antennas during a non-initial time interval; and
a second sequence encoder, coupled to said first sequence encoder, that further provides (N-1) alternative gain retraining sequences to (N-1) remaining transmit antennas, respectively, during said non-initial time interval to retrain receive gains for said multiple concurrent data transmissions; and
a MIMO receiver, employing M receive antennas, where M is at least two, that retrains said receive gains for said multiple concurrent data transmissions.

16. The system as recited in claim 15 wherein each of said (N-1) alternative gain retraining sequences is orthogonal to said gain retraining sequence.

17. The system as recited in claim 15 further comprising a preamble having a series arrangement of preamble fields wherein said preamble precedes said gain retraining sequence.

18. The system as recited in claim 17 further comprising a series arrangement of null fields preceding each of said (N-1) alternative gain retraining sequences wherein each of said null fields corresponds to a separate preamble field of said preamble.

19. The system as recited in claim 17 wherein said preamble conforms to a standard selected from the group consisting of:
IEEE 802.11a; and
IEEE 802.11g.

20. The system as recited in claim 15 wherein said gain retraining sequence and said (N-1) alternative gain retraining sequences occur concurrently.

21. The system as recited in claim 15 wherein each of said gain retraining sequence and said (N-1) alternative gain retraining sequences precedes a MIMO preamble.
